(19) United States
(12) Patent Application Publication
(10) Pub. No.: US 2007/0029879 A1
(43) Pub. Date: Feb. 8, 2007

(54) Distribution of universal DC power in buildings

(76) Inventor: James G. Eldredge, Meridian, ID (US)

Correspondence Address: MARGER JOHNSON & MCCOLLOM, P.C., 210 SW MORRISON STREET, SUITE 400, PORTLAND, OR, 97204, US

(21) Appl. No.: 11/198,750

(22) Filed: Aug. 4, 2005

(51) Int. Cl. H02J 1/10

(52) U.S. Cl. 307/18

(57) ABSTRACT

Two embodiments for distributing DC power in a building are provided. In the first embodiment, a centralized DC power converter is connected to the building's standard AC power wiring. The centralized DC power converter generates DC power for at least one DC-powered electronic device. The DC power is routed to DC outlets throughout the building over DC conductor sets. A second embodiment embeds a DC power converter in the outlet, which connects to standard AC power wiring. The embedded DC power converter then generates DC power for at least one DC-powered electronic device. A DC power outlet is also provided which may comprise one or more DC power receptacles or DC power cords and plugs, one or more status indicator LEDs, a retraction mechanism for each of the DC power cords, a cooling fan, and an embedded DC power converter. The DC power converters may be universal DC power converters.

### REFERENCE TO RELATED APPLICATION

Copending U.S. patent application Ser. No. 11/101,036, entitled “Universal DC Power,” filed on Apr. 6, 2005, is incorporated herein by reference.

### BACKGROUND OF THE INVENTION

1. Field of the Invention

The invention relates, generally, to DC power distribution and, more particularly, to distributing and providing connection points for DC power, including universal DC power, in buildings.

2. Description of the Related Art

Currently, most digital devices (especially, personal digital appliances) use DC power as their primary power source. These digital devices also tend to require DC power to be supplied at various voltage levels. However, contrary to AC power, DC power is not directly provided by a power distribution network in buildings. Thus, a digital device must be shipped with its own power source. Typically, the power source is in the form of a “brick” or “wall wart” style supply that converts standard AC power already distributed in a building (120VAC or 220VAC) to the specific DC power required by the particular digital device.

Providing a power supply with each digital device has many disadvantages. (1) Including a DC power supply with each device increases manufacturing costs and, thus, increases the cost to end-users. (2) Extra solid waste is created when a digital device is discarded. Although it may still be functional, the power supply cannot be used with other digital devices since it is specific to the device. (3) Consumers must keep track of which power supply goes with each digital device they own. (4) Dangerous situations may arise when a confused consumer attempts to use the incorrect power supply with the digital device.

Universal DC power solves these problems by providing a way for the digital device to communicate its power requirements to a universal DC power converter. The universal DC power converter then supplies the requested power. However, the universal converter still exists in a separate external “brick” or “wall wart” style supply.

Thus, there is a need for a DC power distribution network in a building and for standard outlets to connect DC-powered devices into this distribution network.

### SUMMARY OF THE INVENTION

In one embodiment of the invention, a power converter capable of providing DC power to one or more DC-powered devices is located in a centralized location in the building. The power converter receives standard AC power (120V or 220V) wired directly from the AC breaker box on its own breaker. The centralized power converter has one or more DC power output terminals. Each one of the terminals is capable of supplying a single DC-powered electronic device. Conductors are connected to the output terminals of the centralized power converter, and the conductors are then routed throughout the building to power outlets located at various convenient points in the building. Upon reaching the power outlets, the conductor is connected to a DC receptacle or DC plug and cord accessible from the face of the power outlet. DC-powered devices are then connected into these outlets.

In another embodiment of the invention, a DC power converter capable of providing DC power to one or more DC-powered electronic devices is embedded in a power outlet. The power converter receives standard AC power (120VAC or 220VAC) directly from the AC conductors normally routed throughout a building to standard AC outlets. The power converter has at least one output receptacle or plug and cord to enable DC-powered devices to connect directly into the power converter through the face of the outlet.

In either embodiment, the power converters may be universal power converters that have the ability to communicate with DC-powered electronic devices and receive power requirements from those devices.

### BRIEF DESCRIPTION OF THE DRAWINGS

The above and other features and advantages of embodiments of the invention will become readily apparent by reference to the following detailed description when considered in conjunction with the accompanying drawings.

FIG. 1 is a diagram showing a distribution of DC power in a building using a centralized power converter.

FIG. 2 is a block diagram of a central power converter.

FIG. 3 is a drawing of a faceplate for an outlet containing one standard AC receptacle and a DC receptacle.

FIGS. 4A and 4B are diagrams illustrating front and side views, respectively, of an outlet containing one standard AC receptacle and one retractable DC power plug and cord.

FIGS. 5A and 5B are diagrams illustrating front and side views, respectively, of a retraction mechanism.

FIG. 6 shows a distribution of DC power in a building using one or more power converters embedded in the power outlet.

FIG. 7 is a drawing of a faceplate for an outlet containing one standard AC receptacle, one DC receptacle, and ventilation grating.

FIGS. 8A and 8B are drawings illustrating front and side views, respectively, of an outlet containing one standard AC receptacle, a DC power converter and one DC receptacle.

FIG. 9 is a schematic diagram of an AC-DC converter used in the DC power converter of FIG. 8.

FIGS. 10A, 10B, and 10C illustrate the circuit boards used in the DC power converter of FIG. 8.

### DETAILED DESCRIPTION OF THE EMBODIMENTS

The invention will be described below with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

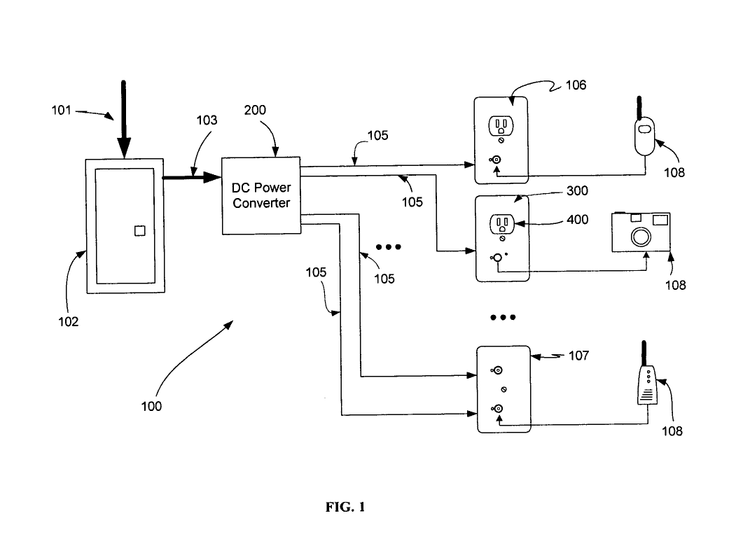

FIG. 1 is a diagram of one embodiment of the invention 100, which comprises a DC power converter 200 that receives standard AC power (e.g., single-phase 120VAC or two-phase 220VAC) 103 directly from a breaker box 102 in a building. The breaker box 102 receives power 101, two-phase 220VAC in this embodiment, from the utility company. The DC power converter 200, which may be a universal DC power converter, converts the AC power 103 into DC power for the one or more DC-powered electronic devices 108. U.S. patent application Ser. No. 11/101,036 describes a universal DC power converter. If the DC power converter 200 is a universal DC power converter, power is supplied according to the parameters communicated by the DC-powered electronic devices 108. One or more conductor sets 105 connect the DC power converter 200 to the outlets 106, 107, and 400. Each conductor set 105 contains a first conductor for conveying positive DC voltage; a second conductor for conveying a common voltage reference; if the DC power converter 200 is a universal DC power converter, a third conductor for communicating DC power parameters from the devices 108 to the DC power converter 200; and a fourth conductor to power a status indicator LED. The DC-powered electronic devices 108 are then plugged into the outlets 106, 107, and 400 to receive DC-power. Faceplate 300 covers the outlet 400.

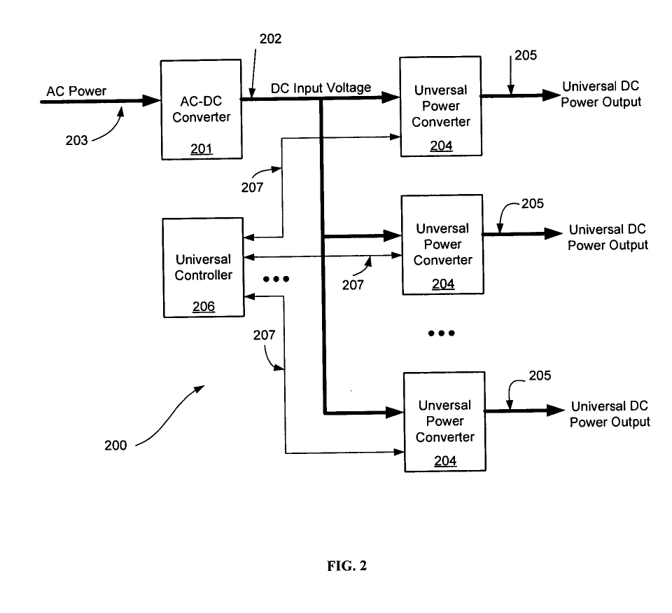

FIG. 2 is a block diagram of an embodiment of the centralized DC power converter 200 in FIG. 1, using universal DC power converters. First, an AC-DC power converter 201 generates a DC input voltage 202 from standard AC power 203. The DC input voltage 202 powers one or more universal power converters 204 that each generates output power 205 for use by a single DC-powered electronic device. These universal power converters 204 are capable of supplying a range of DC voltages and power levels as requested by the device 108. Universal controller 206 controls communication with the DC-powered electronic devices 108 and controls the output power of the universal power converters 204 with signals 207.

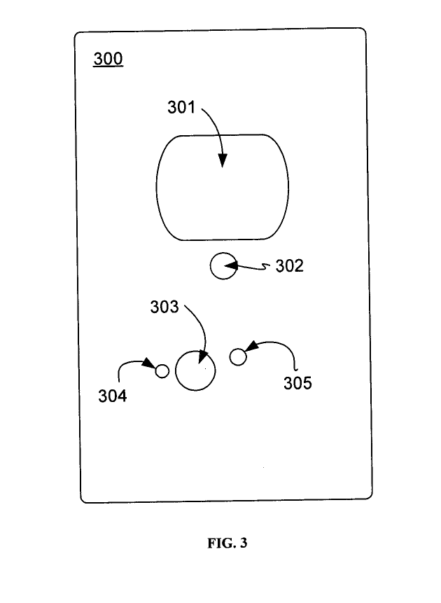

FIG. 3 is a drawing of the faceplate 300 for use with an outlet with one standard AC receptacle and a DC receptacle or power cord. The faceplate comprises a cutout 301 for a standard AC receptacle, a cutout 303 for a DC receptacle or power cord, a cutout 304 for an optional status indicator LED, and a cutout 302 to mount the faceplate to the outlet with a screw.

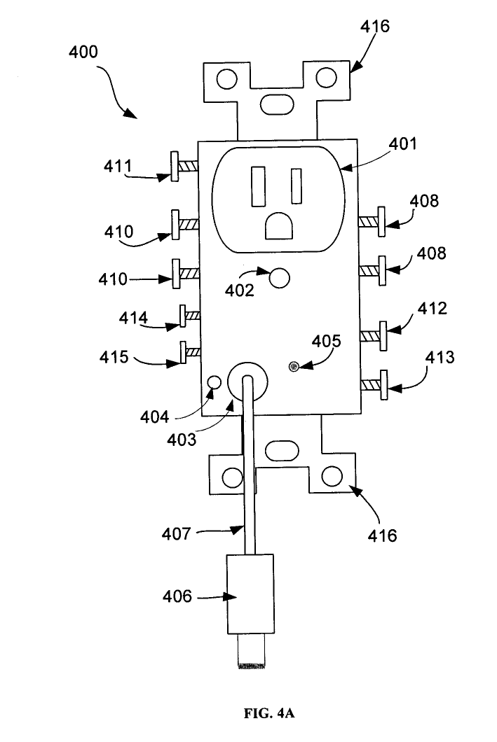

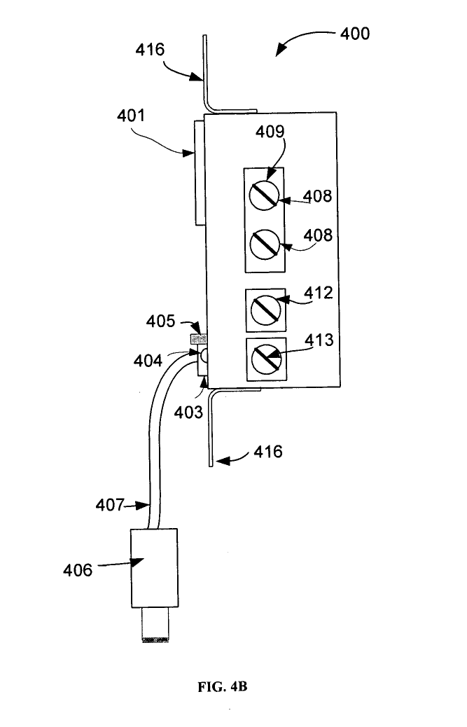

FIGS. 4A and 4B are diagrams showing the front and right sides, respectively, of an outlet 400 with one AC receptacle 401 and one DC receptacle 403. The outlet 400 contains a standard AC receptacle 401. Standard AC power, single phase 120VAC in this embodiment, is connected to the outlet 400 to power the AC receptacle 401: the hot line is connected to lug screws 408; the neutral line is connected to lug screws 410; and the earth ground is connected to lug screw 411. A conductive plate 409 allows AC current to flow between lug screws 408 and 410, respectively, so that outlets 400 can be daisy-chained.

The DC receptacle 403 of outlet 400 comprises a DC power cord 407 attached to a DC power plug 406. A universal DC power conductor set 105 (FIG. 1) is connected to the outlet 400 to power the DC power cord 407 and DC power plug 406: the first positive conductor is connected to lug screw 412; the common conductor is connected to lug screw 413; an optional third conductor for communications is connected to lug screw 414; and the fourth conductor is connected to lug screw 415 to power a status indicator LED 404. The outlet 400 may also comprise a bulk capacitor (not shown) with its positive terminal electrically connected to the lug screw 412 for the first conductor and its negative terminal electrically connected to the lug screw 413 for the common conductor. The bulk capacitor, which may be situated between the lug screws 412 and 413 and the DC power cord 407, mitigates the effects of inductance in the conductor set 105 connecting the outlet 400 to the centralized DC power converter 200 when the loading of the DC-powered electronic device changes quickly. Mounting brackets 416 allow the outlet 400 to be mounted in a standard mounting box, and screw hole 402 allows a faceplate 300 to be mounted to the outlet 400.

A retraction mechanism can be employed to retract and coil the DC power cord 407 into the outlet 400 for storage. A user can pull the DC power cord 407 out of the outlet 400 for connection to a DC powered electronic device. When the connection is no longer need, the user can push a retraction button 405, which causes the DC power cord 407 to be pulled back into the outlet 400.

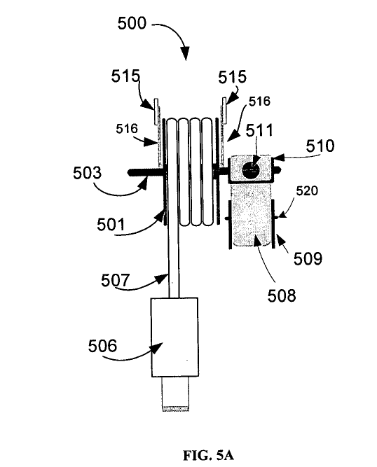

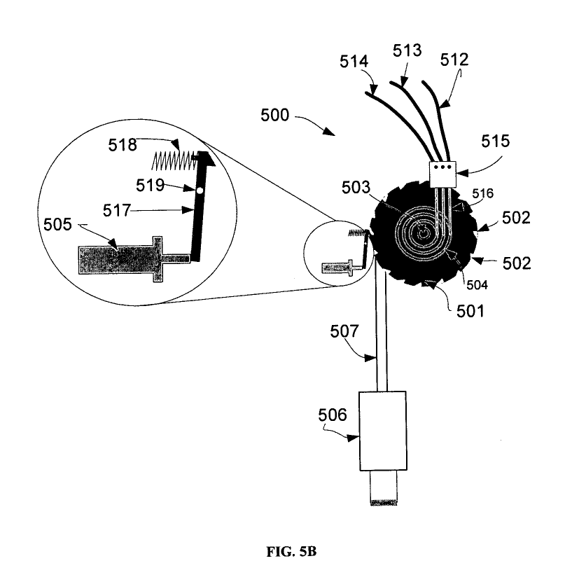

FIGS. 5A and 5B show front and side views, respectively, of the retraction mechanism 500 used to retract a power plug 506 and cord 507 into the outlet 400 (FIG. 4).

The DC power cord 507 (40″ long in one embodiment) is coiled around a spool consisting of an axle 503 and side plates 501 (1″ in diameter in one embodiment). In one embodiment, the axle 503 and side plates 501 are mechanically connected in a rigid manner to form a solid piece. As shown in FIG. 5B, the side plates 501 contain triangular ratchet grooves 502 along the outside edge in a regular pattern, and conductive strips 504 to convey the electrical power from the stationary conductors 512, 513, and 514 to the rotating DC power cord 507. The stationary conductor 512 is the positive DC voltage; the stationary conductor 513 is the common DC voltage; and the stationary conductor 514 is an optional third conductor for communicating with the DC device.

One end of each of the stationary conductors 512, 513, and 514 is connected to a small pass-through board 515 to which stationary fingers 516 are mounted. The stationary fingers 516, in turn, make mechanical contact with the conductive strips 504 providing an electrical connection from stationary conductors 512, 513, and 514 to the power cord 507. The other end of the stationary conductors 512, 513, and 514 is electrically connected to a threaded base into which the lugs 412, 413 and 414 are screwed into, respectively.

The pass-through board 515 is mounted to the body of the outlet 400, and the axle 503 mounts into concave indentions in the body of the outlet 400.

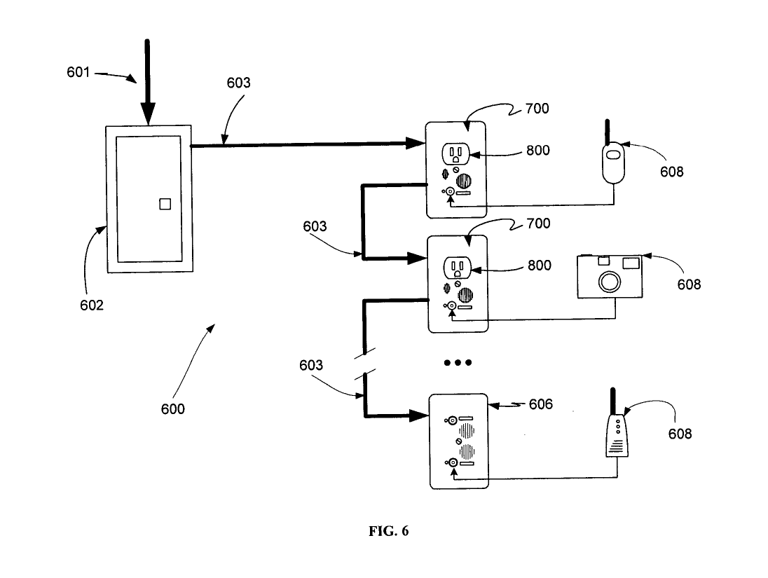

As shown in FIG. 5A, axle 503 contains a wider (0.25″ in this embodiment) diameter output drum 510. The loose end of an extension spring 508 is attached to the output drum 510 with a small screw 511. As the power cord 507 is pulled from the outlet 400, the extension spring 508 is wound around the output drum 510, storing energy for retraction. Referring back to FIG. 5B, ratchet arm 517 is held in place by a small rod placed through pivot hole 519 and mounted to the body of the outlet 400 and is pushed into ratchet grooves 502 by coil spring 518. When the user has pulled the desired length of power cord 507 from outlet 400, the cord is held at that length when the ratchet arm 517 catches a ratchet groove 502 and prevents the axle 503 and side plates 501 from turning. When the user pushes retraction button 505, the ratchet arm 517 pivots away from the side plate 501 and disengages from ratchet groove 502. The cord is now free to retract powered by the energy stored in the extension spring 508. The extension spring 508 is mounted to the body of the outlet 400 by an axle 520 running through mount 509 and extension spring 508, upon which extension spring 508 can rotate. FIG. 6 is a diagram of another embodiment of the invention 600. In this embodiment, standard AC power is received from the utility company (two-phase 220VAC) via conductor 601 into a breaker box 602. From the breaker box 602, AC power is routed to outlets 606 and 700 via conductors 603 (single-phase 110VAC in one embodiment or two-phase 220VAC in another embodiment). The outlets 606 and 700 comprise DC power converters to convert the AC power received from conductor 603 into the DC power requested by the DC-powered electronic devices 608. The DC power converters embedded in the outlets 606 and 700 may be standard DC power converters or universal DC power converters. Where a DC-powered electronic device is not compatible with universal DC power standards, the user may select the appropriate voltage level from a slide switch accessible from the faceplate 800. The faceplate 800 covers the outlet 700.

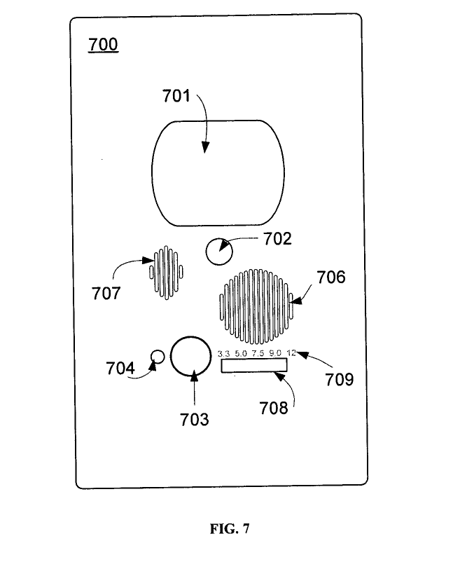

FIG. 7 is a drawing of faceplate 700 for use with an outlet with one standard AC receptacle and a DC receptacle or power cord. Cutout 701 is for a standard AC receptacle; cutout 703 is for a DC receptacle or power cord; cutout 704 is for an optional status indicator LED; and cutout 702 is to mount the faceplate 700 to the outlet with a screw. The faceplate 700 also comprises ventilation gratings 706 and 707 to allow airflow through the faceplate 700 and outlet 800. Cutout 708 is for a voltage selector switch and embossing 709 indicates the voltage levels of various switch settings.

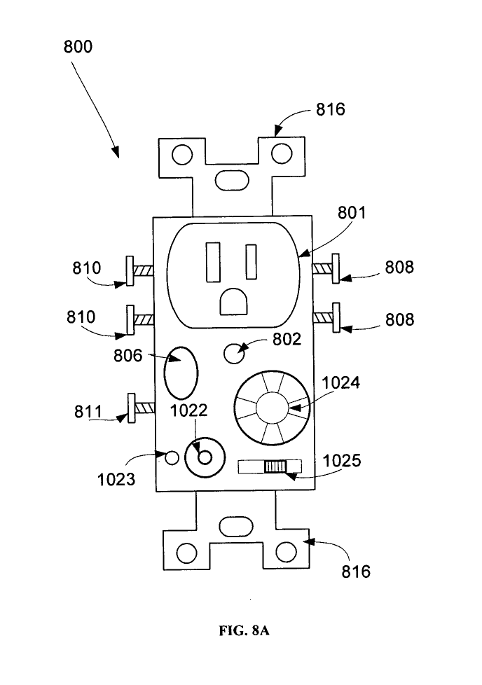

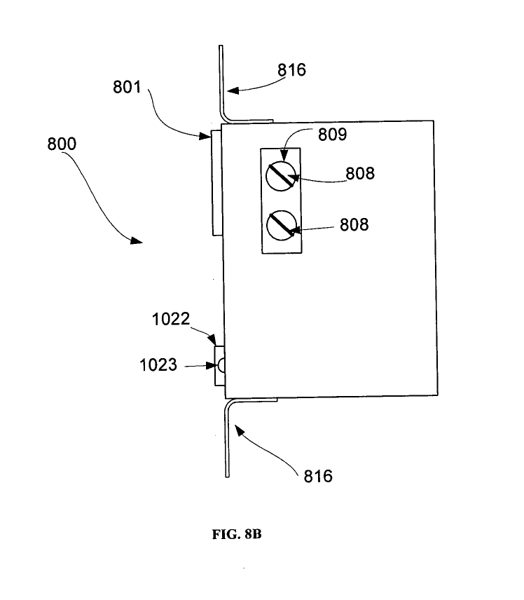

FIGS. 8A and 8B are drawings illustrating front and side views, respectively, of outlet 800 comprising one AC receptacle, one DC receptacle, and a DC power converter. The outlet 800 comprises a standard AC receptacle 801. Standard AC power, single phase 120VAC in this embodiment, is connected to the outlet 800 to power the AC receptacle 801 and a DC power converter 1000: the hot line is connected to lug screws 808; the neutral line is connected to lug screws 810; and the earth ground is connected to lug screw 811. A conductive plate 809 allows AC current to flow between lug screws 808 and 810, respectively, so that outlets can be daisy-chained.

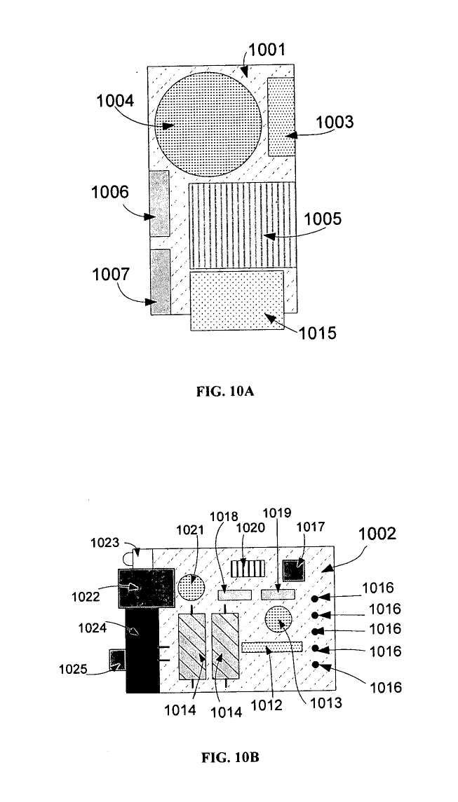

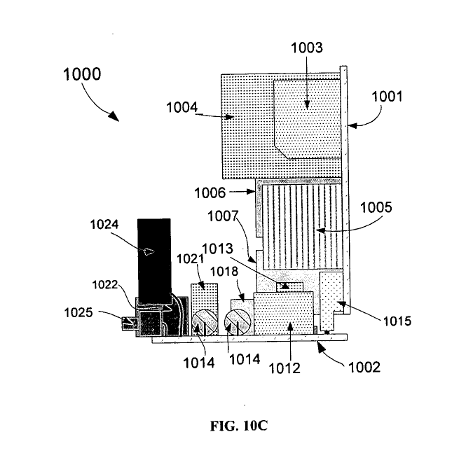

The outlet 800 comprises a DC power converter (universal or otherwise) 1000 (FIG. 10) and a DC receptacle 1022. DC power is connected from the DC power converter 1000 to the DC receptacle 1022: the conductors comprise a first positive conductor, a second common conductor, and an optional third conductor for communication with the DC-powered electronic device. The DC power converter 1000 also connects to a status indicator LED 1023. Mounting brackets 816 allow the outlet 800 to be mounted in a standard mounting box, and screw hole 802 allows a faceplate 700 to be mounted to the outlet 800. Exhaust fan 1024 is controlled by the DC power converter 1000 to provide airflow in outlet 800. Fresh ambient air is pulled into the outlet 800 through air intake 806. Slide switch 1025 selects a voltage level for the DC power converter to supply in case the DC-powered electronic device is not universal DC compatible.

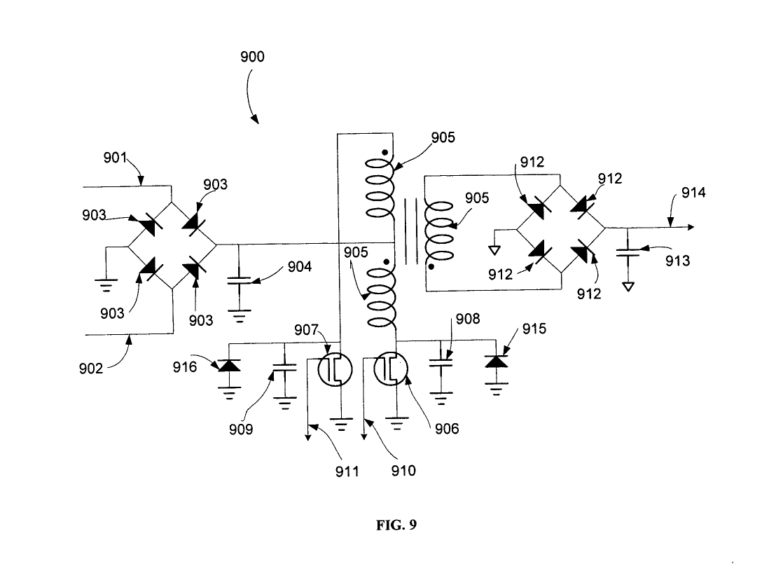

FIG. 9 is a schematic diagram of the AC-DC converter portion of the DC power converter 1000 embedded in outlet 800. Because of the space limitations of outlet 800, the implementation of the AC-DC converter cannot use a standard 60 Hz AC transformer. A 60 Hz transformer providing reasonable power would be too large or a smaller one would not provide sufficient power to be useful. Therefore, the standard 60 Hz AC power must be rectified into a primary DC voltage, modulated at a higher frequency (approximately 100 KHz in this embodiment), stepped-down and isolated through a smaller transformer made for higher frequency operation, and then rectified and filtered for use by the DC power converter.

The AC-DC converter 900 receives AC power (120VAC in one embodiment) from a hot conductor 901 and a neutral conductor 902. The AC power is rectified by bridge rectifier 903 and filtered by capacitor 904 to form a primary DC voltage (160 volts nominal in one embodiment). This primary DC voltage is fed into the center tap of the primary winding of a high frequency power transformer 905. Transformer 905, NMOS transistors 906 and 907, and capacitors 908 and 909 form a tuned, high efficiency class-C push-pull power converter. Transistors 906 and 907 conduct when their gates are driven high (+5V in one embodiment) through conductors 910 and 911, respectively, by a class-C power converter controller (integrated into a universal DC power converter in one embodiment). The secondary winding of transformer 905 induces an AC voltage across bridge rectifier 912 whose output is filtered by capacitor 913 to product the DC input voltage 914. Dampening diodes 915 and 916 protect the transistors 906 and 907, respectively, from negative voltage spikes that would otherwise damage the transistors' 906 and 907 gate oxide.

In one embodiment, each half of the primary winding of transformer 905 has a 1 mH inductance and capacitors 908 and 909 have a 0.01 μF capacitance. The gate conductors 910 and 911 are pulsed with 1 μs wide pulse at a varying frequency. The phase of the pulses on 910 and 911 are 180 degrees out of phase. As the load seen by the DC input voltage 914 increases, the period of the pulses on gate conductors 910 and 911 is decreased until it is at 6 μs. If the period of gate conductors 910 and 911 is reduced below 6 μs, the efficiency of circuit 900 is reduced. If the load seen by the DC input voltage 914 is reduced, the period of the pulses on gate conductors 910 and 911 is increased in increments of 2 μs to maintain class-C efficiency. If a load is such that it falls between two 2 μs increments, the controller that drives gate conductors 910 and 911 may switch between the two increments in such a way that the average of all the pulse periods matches the load.

FIGS. 10A, 10B, and 10C are drawings of the two circuit boards 1001 and 1002 comprising a universal DC power converter embedded in the outlet 800 including major components. A top view of 1001 and 1002 is shown in FIGS. 10A and 10B, respectively, and a side view of the circuit boards as they are connected together 1000 is shown in FIG. 10C. Circuit board 1001 implements most of the AC-DC converter 900. A first bridge rectifier 1003 and filter capacitor 1004 create a primary DC voltage from standard AC power (single-phase 120VAC in one embodiment). This voltage is used to create a modulated current through transformer 1005, which is gated by NMOS transistors 1006 and 1007. The two terminals of the secondary windings are connected to a second circuit board 1002, along with the control signals for the gates of transistors 1006 and 1007 and a ground conductor, through connector 1015 and terminals 1016.

Circuit board 1002 converts the power provided from the secondary winding of transformer 1005 into the DC input voltage of the power converter. Circuit board 1002 also converts the DC input voltage to a voltage level usable by an attached DC-powered electronic device. A second rectifier 1012 and filter capacitor 1013 rectify the current and voltage from the secondary of transformer 1005 into the DC input voltage for the universal DC power controller chip 1017. A universal DC power controller chip 1017 comprises: a controller for the gates of transistors 1006 and 1007 to maintain the DC input voltage at a constant level (32V in one embodiment) under varying loads; a universal DC controller for communicating with an external DC-powered electronic device; a DC-DC buck converter for converting the DC input voltage to the voltage requested by the DC-powered electronic device using transistors 1018 and 1019, inductor 1020, and capacitor 1021; a current monitor that uses current sense resistors 1014 to measure the amount of current delivered to the DC-powered electronic device; an LED driver circuit to control a status LED 1023; a temperature monitor to measure the temperature of the board; and a fan controller to regulate the speed of a DC fan 1024 based on the board temperature. DC fan 1024 expels heated air from the outlet 800 while cooler air is drawn into the outlet 800 through air intake 806. In one embodiment, the DC fan 1024 is not mounted directly to the circuit board 1002; rather, the DC fan 1024 mounts to the body of the outlet 800. The two wires from DC fan 1024 connect to the circuit board 1002. The external DC-powered electronic device connects to the outlet 800 through the DC receptacle 1022. An indicator LED 1023 indicates status to the user. In the case that the connected DC-powered electronic device is not compatible with universal DC standards, the user may select an appropriate voltage level using slide switch 1025.

All components comprising the circuit boards of the universal power converter 1000 are currently available from common electronics vendors, except for the universal DC power controller chip 1017.

Referring to FIGS. 1, 4A, 4B, 5A, 5B, 8A, and 8B, if the universal DC power algorithm does not need the third conductor for communication between the converter 200 or 1000 and the device 108 or 608, the DC receptacle 1023 and DC power jack/cord 406/407 and 506/507 can be a commonly available DC power jack, cord or plug, or another two conductor DC power jack, cord or plug designed specifically for that universal DC standard. If the universal DC power algorithm does require the third conductor for communication between the converter 200 or 1000 and the device 108 or 608, the DC receptacle 1023 and DC plug/cord 406/407 506/507 will require a third contact to connect the communication conductor from the device 108 or 608 to the converter 200 or 1000.

Having described exemplary embodiments of the invention, it is noted that modifications and variations can be made by persons skilled in the art in light of the above teachings. Therefore, it is to be understood that changes may be made to embodiments of the invention disclosed that are nevertheless still within the scope and the spirit of the invention as defined by the appended claims.

What is claimed is:

1. A DC power distribution system, comprising:
a DC power converter configured to provide DC power to at least one DC-powered electronic device;
at least one DC conductor set for coupling the DC power converter to at least one DC outlet, the DC outlet for connecting the at least one DC-powered electronic device to the DC power distribution system.

2. The system of claim 1, wherein the DC power converter comprises:
an AC-DC converter for converting AC power to a DC input voltage;
at least one DC-DC power converter coupled to the AC-DC converter for converting the DC input voltage to a DC output voltage; and
a DC power controller coupled to the at least one DC-DC power converter for controlling the DC output voltage to the DC-powered electronic device.

3. The system of claim 1, wherein the DC power converter comprises a universal DC power controller for controlling the DC power to the at least one DC-powered electronic device.

4. The system of claim 1, wherein the DC conductor set comprises:
a first conductor for conducting positive voltage to the DC outlet; and
a second conductor for providing a reference voltage to the DC outlet.

5. The system of claim 4, wherein the DC-powered electronic device connected to the DC outlet communicates its power request to the DC power converter via the first conductor.

6. The system of claim 4, wherein the DC conductor set further comprises a third conductor for controlling a status indicator.

7. The system of claim 4, wherein the DC conductor set further comprises a fourth conductor for communicating power requests from a DC-powered electronic device connected to the DC outlet to the DC power converter.

8. The system of claim 1, wherein the DC outlet comprises at least one DC receptacle.

9. The system of claim 8, wherein the DC outlet further comprises at least one status indicator.

10. The system of claim 8, wherein the DC outlet further comprises at least one standard AC receptacle.

11. The system of claim 1, wherein the DC outlet comprises at least one DC power plug connected to the DC outlet by a DC power cord.

12. The system of claim 11, wherein the DC outlet comprises at least one status indicator.

13. The system of claim 11, wherein the DC outlet further comprises a retraction mechanism means to reel the DC power cord into the DC outlet.

14. The system of claim 13, wherein the DC outlet further comprises a user accessible button that is pushed to initiate retraction of the DC power cord into the DC outlet.

15. The system of claim 11, wherein the DC outlet further comprises at least one AC receptacle.

16. The system of claim 1, wherein the DC outlet comprises a selection means allowing the user to select a DC voltage level.

17. A DC power outlet, comprising:
at least one DC receptacle for connecting at least one DC-powered electronic device to a DC power distribution system.

18. The DC power outlet of claim 17, further comprising at least one DC power plug connected to the DC power outlet by a DC power cord.

19. The DC power outlet of claim 18, further comprising at least one status indicator.

20. The DC power outlet of claim 18, further comprising a retraction mechanism to reel the DC power cord into the DC outlet.

21. The DC power outlet of claim 20, further comprising a user accessible button that is pushed to initiate retraction of the DC power cord into the DC outlet.

22. The DC power outlet of claim 21, further comprising at least one AC receptacle.

23. The DC power outlet of claim 17, further comprising at least one DC power converter.

24. The DC power outlet of claim 23, wherein the at least one DC power converter comprises:
a first rectifier and filter means for converting an AC line voltage to a primary DC voltage;
at least one switching transistor for modulating current through a primary winding of an isolation transformer at a higher frequency than the AC line voltage; and
a second rectifier and filter means for converting a modulated voltage induced on a secondary winding of the isolation transformer into a DC input voltage for the embedded DC power converter.

25. The DC power outlet of claim 24, wherein the at least one DC power converter is a universal DC power converter.

26. The DC power outlet of claim 17, further comprising a fan.

27. The DC power outlet of claim 17, further comprising at least one standard mounting bracket for mounting the DC power outlet in a standard in-wall or wall-mounted outlet box.

28. The DC power outlet of claim 17, further comprising a means for connecting standard AC power wiring.

29. The DC power outlet of claim 17, further comprising:
a means for connecting a first conductor carrying a positive DC voltage, and
a means for connecting a second conductor carrying a reference DC voltage.

30. The DC power outlet of claim 29, further comprising a means for connecting at least one conductor for powering a status indicator.

31. The DC power outlet of claim 29, further comprising a means for connecting at least one conductor for communicating power requirements from the DC-powered electronic device to a centralized DC power converter.

32. The DC power outlet of claim 17, further comprising a selection means allowing the user the select a DC voltage level.

33. A centralized DC power converter comprising:
a means to connect the centralized DC power converter to standard AC power;
an AC-DC converter to generate a DC input voltage from the AC power;
at least one DC-DC power converter to convert a DC input voltage to a DC output voltage; and
a means to connect the centralized DC power converter to at least one DC conductor set.

34. The centralized DC power converter of claim 33, further comprising a universal DC power controller coupled to the at least one DC-DC power converter.
